(19) United States
(12) Patent Application Publication
(10) Pub. No.: US 2025/0019212 A1
(43) Pub. Date: Jan. 16, 2025

(54) POWERED HANDHELD CHAIN DRIVER AND METHODS

(71) Applicant: Alan Baldasari, Negaunee, MI (US)

(72) Inventor: Alan Baldasari, Negaunee, MI (US)

(21) Appl. No.: 18/733,730

(22) Filed: Jun. 4, 2024

Related U.S. Application Data
(60) Provisional application No. 63/526,908, filed on Jul. 14, 2023.

(51) Int. Cl. B66D 3/20; B66D 3/16

(52) U.S. Cl. CPC B66D 3/20; B66D 3/16

(57) ABSTRACT

A powered handheld chain driver for driving a chain from a chain fall thereby minimizing the effort required to raise and lower loads. The chain driver comprises an integrated or separated drive motor driving a chain sprocket that drives the chain. The chain sprocket is positioned between a pair of vertical spaced chutes and is engaged within a portion of the chutes. Each spaced chute is split and can be opened in a release configuration, for loading and unloading a chain therein. The chutes also comprise a drive configuration wherein the chutes are closed and the chains are captured within the chutes during chain driver operation. Lateral of each chute is a hand assembly comprising handles for supporting the chain driver with the user's hands. A battery is mounted on one side of the chain driver to supply power to the drive motor via one or more power switches.

### CROSS REFERENCE TO RELATED APPLICATIONS

This application claims priority to Provisional Patent Application No. 63/526,908 filed Jul. 14, 2023, the entire disclosure of which is hereby incorporated by reference and relied upon.

### BACKGROUND OF THE INVENTION

### Field of the Invention

The invention relates generally to chain falls, and more particularly to powered handheld chain drivers for use with chain falls.

### Description of Related Art

Chain falls are widely used to gain a mechanical advantage when lifting heavy loads by hand. Many of the chain falls on the market are able to lift upwards of 1 ton via hand pulling of chains through the chain fall by a human. Despite the huge mechanical advantage afforded by the use of the chain fall, repeated use of the device can lead not only to muscle fatigue but also to injuries to the user's upper extremities. Such injuries can include repetitive over-use syndromes.

What is needed are devices that will assist in operation of a chain fall device that are well balanced and easy to hold, simple to apply to the chain fall hand chains, easy to remove, easy to operate while holding the device's handles, operable without power cords, that effectively moves the hand chains without binding, and that eliminates the need for high stress repetitive motion that is associated with over-use syndromes.

### SUMMARY OF THE INVENTION

Disclosed herein is a powered handheld chain driver that fulfills the needs described above.

In one form, a chain driver comprises a chain sprocket for driving chain.

In one form, the chain driver comprises a first hand assembly and a second hand assembly wherein the first hand assembly comprises a first handle for grasping by a user's hand and the second hand assembly comprises a second handle for grasping by the user's other hand.

In one form, the chain driver comprises a generally central core plate to structurally support main components of the chain driver.

In one form, the chain driver comprises a circular chain sprocket for driving a hand chain from a chain fall on opposing sides of the chain sprocket.

In one form, a drive motor is coupled to a drive shaft to drive the chain sprocket.

In one form, the drive motor, drive shaft, and chain sprocket are positioned medially on the front side (anterior side) of the core plate.

In one form, a battery is positioned medially on the rear (posterior) said of the core plate.

In one form, the first handle and second handle are aligned in the same plane as the core plate.

In one form, the battery is positioned on one side of the core plate, and the drive motor and chain sprocket on the opposite side of the core plate which causes the chain driver to be balanced in the user's hands during operation.

In one form, a motor shaft extending from the drive motor is positioned vertically in the chain driver.

In one form, a motor shaft extending from the drive motor is positioned horizontally.

In one form, the drive shaft is interrupted by a drive coupler between two portions of the drive shaft.

In one form, a bevel gear set is positioned between a motor shaft of the drive motor and the drive shaft for the transfer of torque therebetween.

In one form, adjacent the first handle and/or the second handle or both, is a power switch for activation by the user without need for removal of the user's hands from the handles. Activation produces consequent rotation of the chain sprocket to drive the chain fall.

In one form, a first chute assembly and a second chute assembly are positioned parallel to each other on lateral sides of the chain sprocket such that sprocket windows on the chain sprocket open into the respective chute assemblies.

In one form, the first hand assembly and second hand assembly are able to translate laterally on one or more rails away from the core plate.

In one form, chutes associated with the first hand assembly and second hand assembly open by lateral translation of respective first hand assembly and second hand assembly with respect to the core plate.

In one form, translation of the hand assemblies is completed on rails, rods, or similar linear structure.

In one form, opening of the chutes is controlled by a hinge.

In one form, the first hand assembly and second hand assembly are biased medially for automatic closure of the chutes.

In one form, the first hand assembly and second hand assembly are secured, assuring the chutes remain closed during operation, by use of a pivot latch that latches a respective hand assembly to the core plate or member coupled to the core plate.

In one form, handles associated with the hand assemblies are orientated generally vertical.

In one form, a chain plate is biased against hand chains in a chute during operation to assure positive engagement between the hand chain and the chain sprocket.

In one form, the battery is seated in a battery bracket coupled to a rear side (posterior) of the core plate.

In one form, portions of the drive motor and chain sprocket are covered with a shroud.

In one form, a foot base secures a bottom side of the chain driver and extends from a front (anterior) to back (posterior) portion of the chain driver.

In one form, a method for using a powered chain driver to drive a hand chain comprises the following steps. Obtaining a chain fall secured to an overhead anchor. Obtaining a powered chain driver as disclosed herein. Grasping the chain driver with left hand on the left handle and right hand on the right handle while facing the hand chains extending vertically from the chain fall. Depressing the pivot latch(s) to release the hand assemblies. Pulling the hand assemblies laterally to open the chutes and providing access to them. Aligning the chutes with the hand chains and positioning the chain driver such that the chains are aligned with the chute axes. Releasing the lateral forces to allow the chutes to close over the hand chains. Depressing a power switch on the chain driver to activate power to the drive motor, thus driving the chain sprocket and hand chain to raise or lower a load suspended by the chain fall. Releasing the power switch when the load is raised or lowered to the desired position. Depressing the pivot latches to release the hand assemblies. Pulling the hand assemblies laterally (or pivoting them open for hinged models) to access the chutes and moving the chain driver away from the hand chains. Charging the chain driver battery as needed.

### BRIEF DESCRIPTION OF THE SEVERAL VIEWS OF THE DRAWINGS

These and other features and advantages of the present invention will become more readily appreciated when considered in connection with the following detailed description and appended drawings, wherein each drawing is according to one or more embodiments shown and described herein, and wherein:

FIG. 1 depicts a front perspective view of a powered handheld chain driver;

FIG. 2 depicts a rear perspective view of the chain driver of FIG. 1;

FIG. 3 depicts a top perspective exploded view of the chain driver of FIG. 1;

FIG. 4 depicts an opposing top perspective exploded view of the chain driver of FIG. 1;

FIG. 5 depicts a rear perspective view of the chain driver of FIG. 1 with chutes opened for loading chains from a chain fall;

FIG. 6 depicts a top view of the chain driver of FIG. 1 with chutes opened;

FIG. 7 depicts a top perspective view of a first handle of a chain driver;

FIG. 8 depicts an opposed top perspective view of the first handle of FIG. 7;

FIG. 9 depicts a top perspective view of a first hand assembly of the chain driver of FIG. 1;

FIG. 10 depicts an opposed top perspective view of the first handle of FIG. 9;

FIG. 11 depicts a perspective view of a core plate as used in the chain driver of FIG. 1;

FIG. 12 depicts an opposed perspective view of the core plate of FIG. 11;

FIG. 13 depicts a perspective view of a chain sprocket used in the FIG. 1 embodiment;

FIG. 14 depicts an opposed perspective view of a chain sprocket with a drive motor covered by a shroud of the chain driver of FIG. 1;

FIG. 15 depicts a perspective view of the chain sprocket of FIG. 14 with a drive shaft extending through the sprocket;

FIG. 16 depicts a perspective view of the chain sprocket and drive motor of FIG. 14 with shroud removed;

FIG. 17 depicts a side perspective view of the chain sprocket of FIG. 14;

FIG. 18 depicts a top perspective view of a chain driver with shroud removed;

FIG. 19 depicts an opposed top perspective view of the chain driver of FIG. 18;

FIG. 20 depicts a top perspective view of a chain driver with battery removed;

FIG. 21 depicts an opposed top perspective view of the chain driver of FIG. 20;

FIG. 22 depicts a side perspective view of the chain driver of FIG. 20;

FIG. 23 depicts a bottom perspective view of the chain driver of FIG. 20;

FIG. 24 depicts a top perspective view of the chain driver of FIG. 20;

FIG. 25 depicts a bottom perspective view of the chain driver of FIG. 20;

FIG. 26 depicts a top perspective view of the chain driver of FIG. 20 with battery bracket and battery removed;

FIG. 27 depicts a rear perspective view of the chain driver of FIG. 20 with shroud removed;

FIG. 28 depicts an exploded bottom perspective view of the chain driver of FIG. 20;

FIG. 29 depicts an exploded front perspective view of the chain driver of FIG. 20;

FIG. 30 depicts an exploded rear perspective view of the chain driver of FIG. 20;

FIG. 31 depicts a front view of the chain driver of FIG. 20 with the first hand assembly and second hand assembly distracted to open the chutes;

FIG. 32 depicts a rear view of the chain driver of FIG. 20 with the first hand assembly and second hand assembly distracted to open the chutes (battery removed);

FIG. 33 depicts a top view of the chain driver of FIG. 20 with the first hand assembly and second hand assembly distracted to open the chutes (battery removed);

FIG. 34 depicts a bottom perspective view of the chain driver of FIG. 20 with the first hand assembly and second hand assembly distracted to open the chutes;

FIG. 35 depicts a rear perspective view of the chain driver of FIG. 20 with hand chains loaded into the chutes and first hand assembly and second hand assembly spring biased to closed the chutes;

FIG. 36 depicts a front perspective view of the chain driver of FIG. 20 with hand chains loaded into the chutes and first hand assembly and second hand assembly spring biased to closed the chutes;

FIG. 37 depicts a bottom perspective view of the chain driver of FIG. 20 with hand chains loaded into the chutes and first hand assembly and second hand assembly spring biased to closed the chutes;

FIG. 38 depicts a front view of an early prototype of a chain driver wherein the chutes open via a first hinge and a second hinge at respective chutes and the drive shaft is driven by a battery powered drill motor;

FIG. 39 depicts a top perspective view of the chain driver of FIG. 38 wherein the chutes open via a first hinge and a second hinge at respective chutes;

FIG. 40 depicts a side perspective view of the chain driver of FIG. 38 wherein the chutes open via a first hinge and a second hinge at respective chutes;

FIG. 41 depicts a front view of yet another embodiment of a chain driver;

FIG. 42 depicts a bottom perspective view of the chain driver of FIG. 41;

FIG. 43 depicts a rear perspective view of the chain driver of FIG. 41 (battery removed);

FIG. 44 depicts a bottom perspective view of the chain driver of FIG. 41 (battery removed;

FIG. 45 depicts a top perspective view of the chain driver of FIG. 41 with shroud removed;

FIG. 46 depicts a side perspective view of the chain driver of FIG. 41 with shroud removed and gear box casing removed;

FIG. 47 depicts a side view of the chain driver of FIG. 41 with shroud and gear box casing removed;

FIG. 48 depicts a front perspective view of a chain sprocket as used in the chain driver of FIG. 41.

FIG. 49 is a graphic depicting steps utilized in a method of using a chain driver.

### DETAILED DESCRIPTION OF SELECTED EMBODIMENTS OF THE INVENTION

Select embodiments of the invention will now be described with reference to the Figures. Like numerals indicate like or corresponding elements throughout the several views and wherein various embodiments are separated by letters (i.e. 100, 100B, 100C). The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

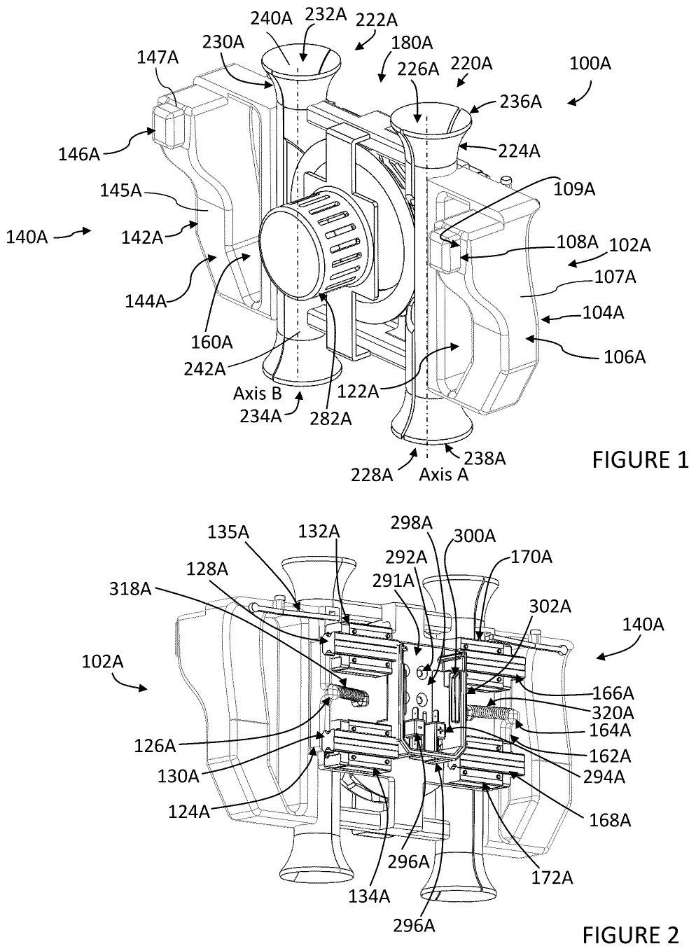

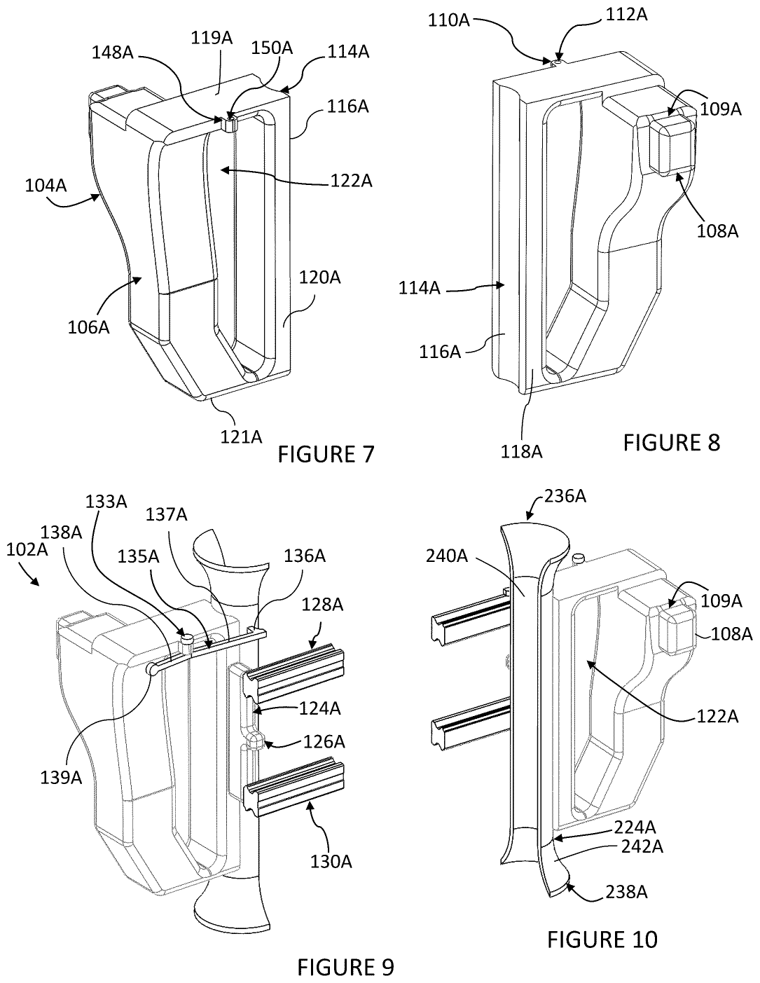

Depicted in FIGS. 1-17 is a chain driver 100A according to one embodiment of the invention. The chain driver comprises a chain drive assembly 180A, a first hand assembly 102A, and a second hand assembly 140A. The first hand assembly 102A, and second hand assembly 140A in this embodiment are positioned on opposing sides of the chain drive assembly 180A which provides engagement and power for low effort movement of chains of a chain fall.

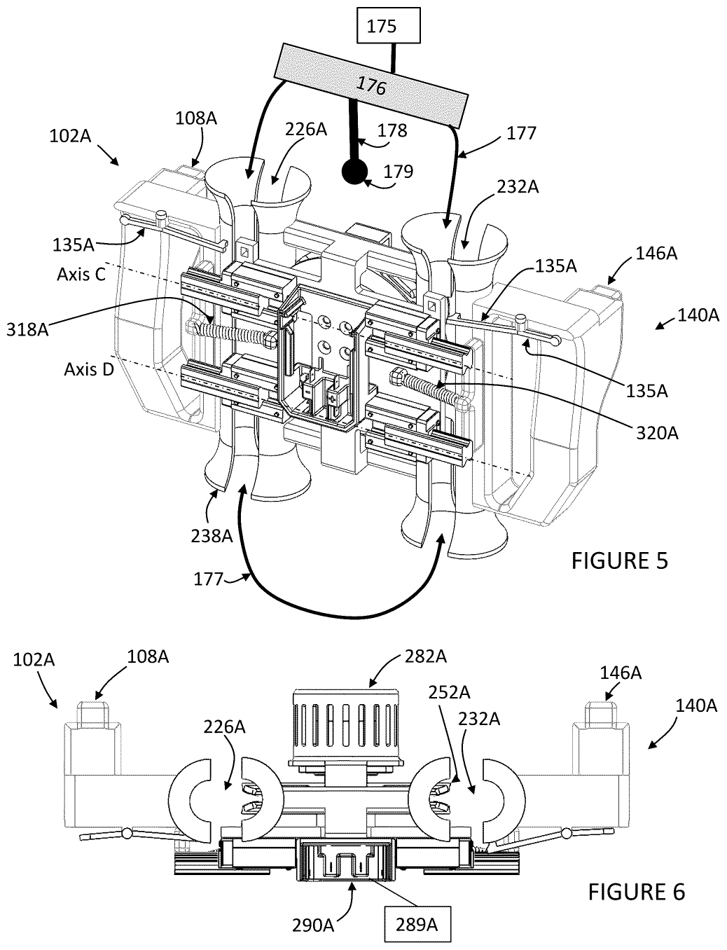

In this embodiment, the chain drive assembly 180A utilizes a core plate 182A as the central rigid component from which the first hand assembly 102A, second hand assembly 140A, and chain drive assembly 180A operate. On one side of the core plate is a drive motor 266A coupled with a drive shaft 267A which in turn is coupled with a chain sprocket 252A which is utilized to power the movement of hand chain 177 in a chain fall 176 which is typically supported overhead by a support beam 175 or other capable anchoring structure (FIG. 5). Movement of the hand chain through the chain fall in one direction causes a consequent lifting of a load 179 via lift chain 178, whereas movement of the hand chain through the chain fall in the opposite direction causes a consequent lowering of a load 179 via lift chain 178.

On the opposing side of the core plate 182A is a battery bracket 290A for securing a battery 289A within the bracket. The weight of the battery and battery bracket assists to oppose the weight of the drive motor and chain sprocket thereby creating a weight balance across the core plate making the chain driver 100A balanced and easier to handle.

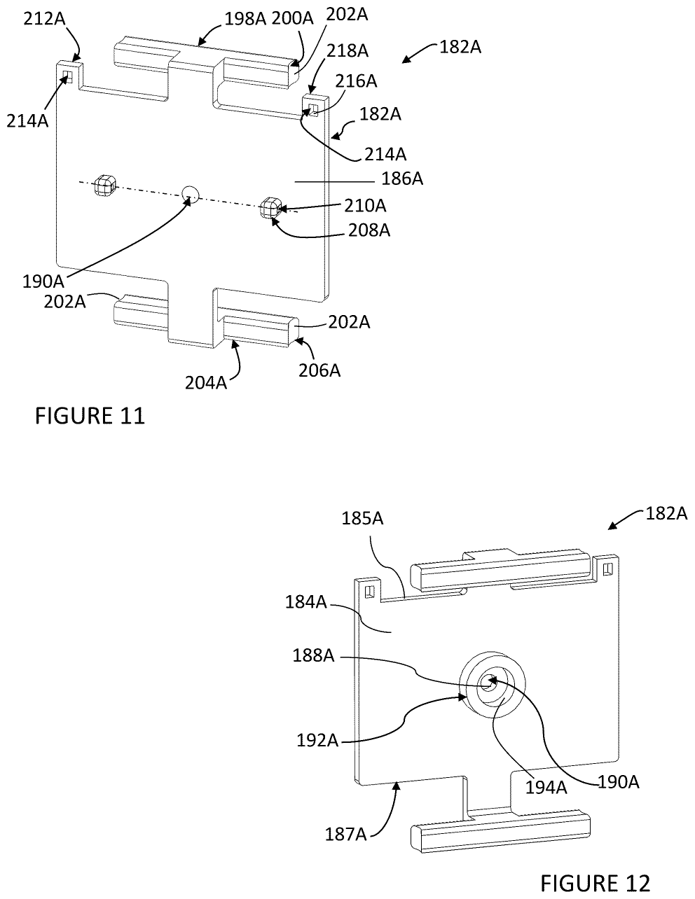

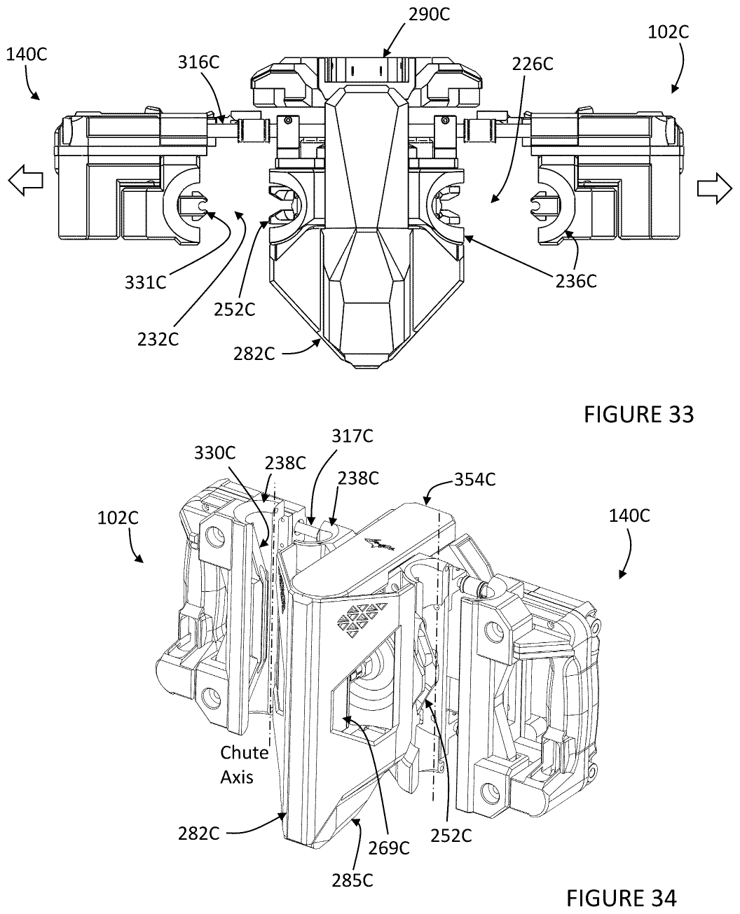

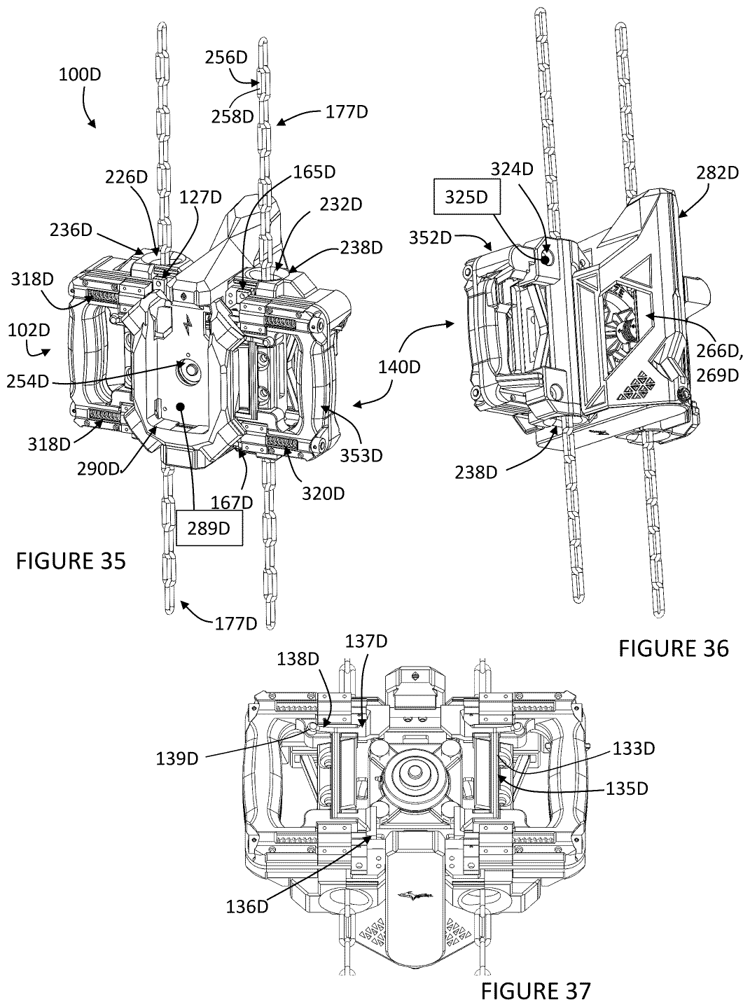

The operational configuration is when the chain driver is held by a user with one handle in each hand and battery facing the user's chest. One skilled in the art will recognize this orientation could be reversed without major loss of function. The core plate 182A is generally rectangular and comprises in an operational configuration an anterior surface 184A facing anteriorly (FIG. 11-12), a superior surface 185A facing superior, a posterior surface 186A facing posteriorly, and an inferior surface 187A facing inferiorly. Generally centered in the core plate 182A is a core drive aperture 190A defined by a core drive surface 188A which extends between the anterior surface and the posterior surface. Extending anteriorly from the anterior surface 184A is a bearing sleeve 192A having a rounded inner sleeve surface 194A for seating of a sprocket bearing 254A to support drive shaft 267A. Extending from the posterior surface 186A are a pair of spaced bias posts 208A with a bias aperture 210A extending therethrough which is configured for retaining the end of a spring. Extending from a superior end in this embodiment is a first latch ear 212A on one side and a second latch ear 218A on the opposite side with a latch cavity 214A defined by a latch cavity face 216 extending therethrough. The latch cavities provide a releasable fixation point for a pivot latch 135A that controls opening and closing of the first chute assembly 220A and second chute assembly 222A. In some embodiments, rail anchors are used as the releasable fixation point. When the chutes are closed about a chain (i.e. FIG. 35), this is the drive configuration. When the chutes are pulled open to insert or release the chain, this is the release configuration (i.e. FIG. 33-34).

Extending from the superior end of the core plate in this embodiment, is a T-shaped upper arm 198A and extending from the inferior end of the core plate 182A is a T-shaped lower arm 204A. At lateral ends of the T of the upper arm 198A is upper core chute wall 200A with core chute face 202A thereon, whereas at lateral ends of the T of the lower arm 204A is lower core chute wall 206A with core chute face 202A thereon. The core chute faces are curved for fixed mating with the outer chute face 242A of the first outer chute 224A (left hand side) and the second outer chute 230A (right hand side) respectively.

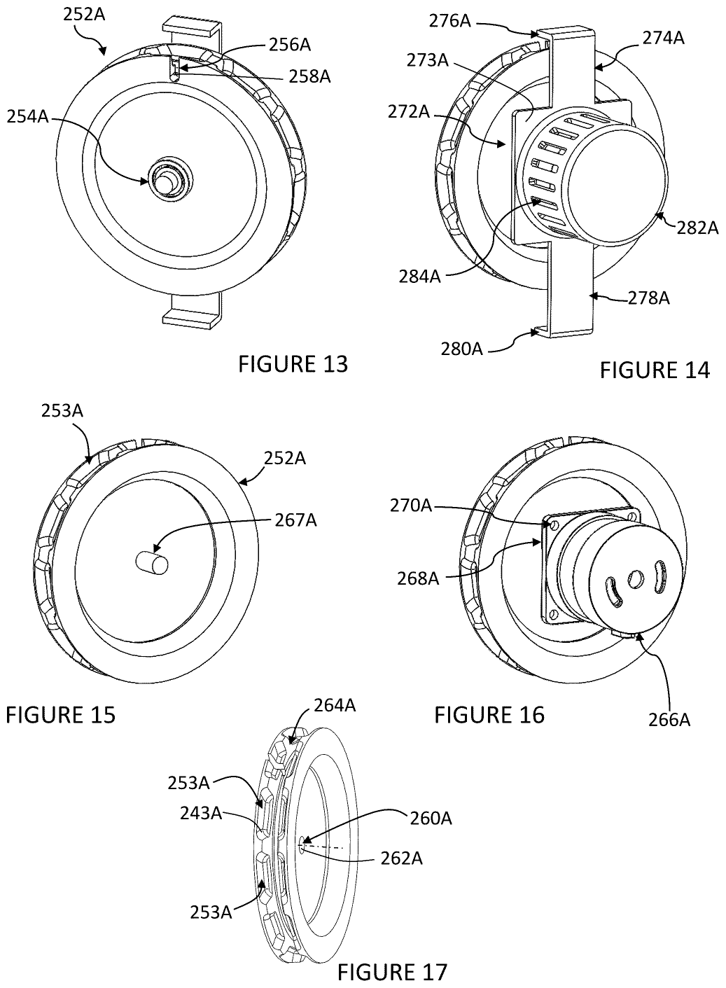

Further to the chain drive assembly 180A, drive shaft 267A extends from bearing sleeve 192A anteriorly through chain sprocket 252A and is then coupled with drive motor 266A wherein the drive motor serves to provide rotational force to the chain sprocket 252A for advancing hand chain 177A when the hand chains are captured within first chute assembly 220A (along axis A) and second chute assembly 222A (along axis B). FIG. 13 depicts an embodiment of a chain sprocket 252A which has a generally disc shaped body. At the center of the chain sprocket is a sprocket drive face 262A extending between opposed sides of the chain sprocket 252A and defining a sprocket drive aperture 260A for seating of the drive shaft 267A therein. Inscribed into the radial edge of the chain sprocket 252A are a plurality of sprocket windows 253A defined by a sprocket window face 243A wherein the sprocket window is sized for seating a chain link therein. A sprocket first recess 264A extends between the sprocket windows encircling the chain sprocket to provide a continuous link between the sprocket windows for seating of the hand chain 177 therein during operation. The drive motor 266A in this embodiment is housed within shroud 282A that covers the drive motor within. The shroud 282A can include one or more cooling vents 284A to release heat from the drive motor during operation.

The shroud 282A can be secured to the drive motor or a drive motor bracket 272A. Extending superiorly in parallel to the core plate 182A from the drive motor bracket 272A is upper motor arm 274A which terminates in upper motor finger 276A which is fixed at upper arm 198A of the core plate 182A. Extending inferiorly in parallel to the core plate 182A from drive motor bracket 272A is lower motor arm 278A which terminates in low motor finger 280A that is fixed at lower arm 204A of the core plate.

In this embodiment, the drive motor 266A comprises a drive motor mount 268A with drive motor mount holes 270A extending therethrough for securing the drive motor in position on the bracket base 273A of drive motor bracket 272A.

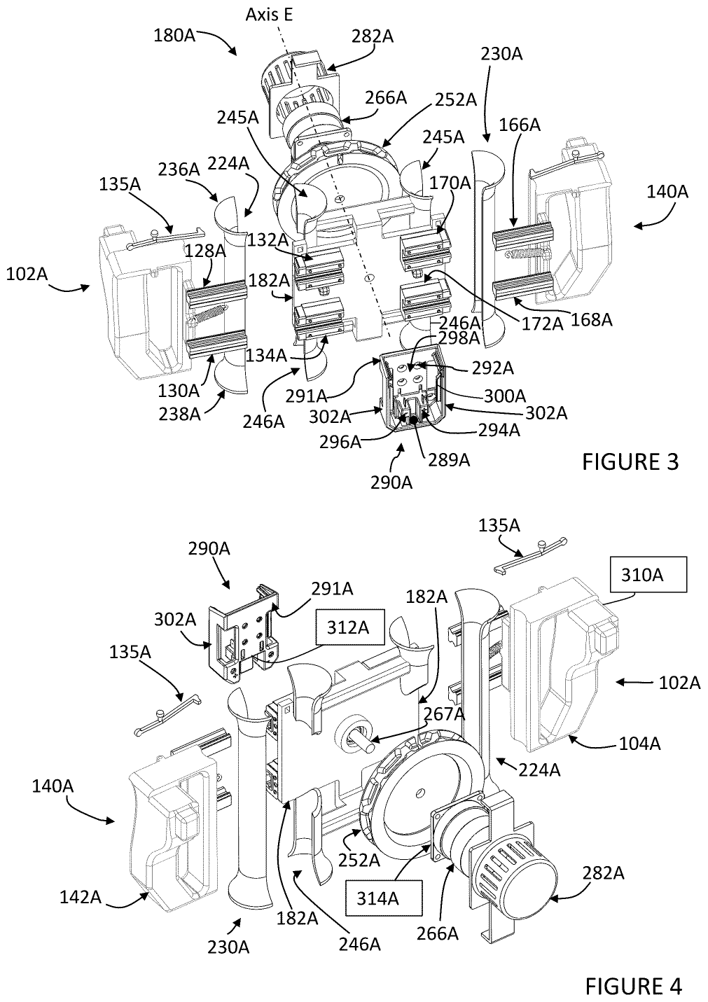

FIG. 3 also depicts an embodiment of a battery bracket 290A that is secured to the posterior face (rear) of core plate 182A. The battery bracket is configured to hold and electrically interface with a removable battery 289A. The battery bracket has a bracket mount wall 291A that sits against the core plate with one or more battery bracket mount holes 292A extending therethrough for receiving fasteners that secure the battery bracket to complementary threaded holes in core plate 182A. A U-shaped side wall 302A defines a bracket cavity 298A and one or more bracket guides 300A can be present to guide a battery in electrical contact with a positive terminal 294A and a negative terminal 296A that bring power to the drive motor 266A through one or more of power conductors 312A at the battery, switch conductors 310A at the switches, and motor conductors 314A at the drive motor.

The first hand assembly 102A (left hand) and the second hand assembly 140A (right hand) are biased towards the core plate in most embodiments using springs, but are distracted away from the core plate using hand distraction forces thus opening the first chute assembly 220A and second chute assembly 222A when loading and unloading hand chains 177 therein. In this embodiment (FIGS. 1-17), the first hand assembly 102A and second hand assembly 140A are mirror images of each other as depicted in the Figures. The first hand assembly 102A is depicted in greater detail in FIGS. 9-10 (equivalent second hand assembly features are shown in parentheses). The first hand assembly comprises a generally rectangular first hand body 104A (second hand body 142A). The first hand body 104A and second hand body 142A have an anterior face 118A facing anterior, a superior face 119A facing superior, a posterior face 120A facing posterior, and an inferior face 121A facing inferior. The first hand body and second hand body comprises respectively a first chute support wall 114A with a first chute support face 116A (second chute support wall 152A with a second chute support face 154A) extending along a medial side of the respective first hand body 104A (second hand body 142A). The first chute support face 116A (second chute support face 154A) are in the form of a rounded elongate channel for securing the respective rounded outer chute face 242A thereon. A first hand aperture 122A (second hand aperture 160) extends through the respective first hand body 104A and second hand body 143A respectively forming a first handle 106A with a first handle face 107A thereon, and a second handle 144A with a second handle face 145A thereon for gripping by the user's left hand on the first handle and right hand on the second handle. Housed within a first power switch cavity 109A within the first handle 106A and extending anterior is first power switch 108A, whereas housed within a second power switch cavity 147A within the second handle 144A and extending anterior is second power switch 146A. Activation of the first power switch induces the drive motor to rotate the chain sprocket 252A in one direction, whereas activation of the second power switch induces the drive motor to rotate the chain sprocket in the opposite direction thereby either elevating or lowering the chain fall supported load 179. Some embodiments include only a single power switch and a two position directional switch to determine the rotation direction that the single power switch will activate. In some embodiments, the power switch(s) cause the chain sprocket to turn at a variable speed.

Extending from the posterior face 120A of the hand bodies is first latch pivot base 110A (second latch pivot base 148A) with a first latch pivot hole 112A (second latch pivot hole 150A) extending vertically therethrough. These structures provide a place for a pivot latch 135A to articulate. The pivot latch comprises a pivot arm 133A extending from the latch for pivoting within the respective latch pivot holes. The pivot latches also comprise an activation arm 138A extending laterally from the pivot arm 133A which terminates in an activation pod 139A that can be enlarged for activation by a user's finger for releasing the latch. Extending medially from the pivot arm 133A is a latch leg 137A that terminates in a latch foot 136A that releasably engages a latch cavity 214A on core plate 182A. When unlocked from the latch cavity, the first hand assembly and second hand assembly can be distracted laterally by user hand force on the respective handles thereby opening the chutes.

As depicted in FIG. 9, a first hand rail block 124A (second hand rail block 162A) extends from posterior face 120A of the respective first handle and second handle. Elevated from the respective hand rail block is a first hand retention post 126A (second hand retention post 164A) with an aperture for capturing one end of a respective first retraction spring 318A and second retraction spring 320A. The opposing ends of the first retraction spring 318A and the opposing end of the second retraction spring 320A are seated in the nearest bias post 208A whereby the spring tension biases the corresponding first hand assembly 102A and second hand assembly 140A towards the midline of core plate 182A. Extending medially from the upper end of the first hand rail block 124A is a first upper rail 128A whereas, extending from a lower end of the first hand rail block is a first lower rail 130A. Likewise, extending medially from the upper end of the second hand rail block 162A is a second upper rail 166A whereas, extending from a lower end of the second hand rail block 162A is a second lower rail 168A. The upper rails and lower rails are slidingly captured in respective upper and lower rail receivers as noted in FIGS. 2 and 5 for example. This capture can be a tongue and groove relationship or other known configurations such a post and hole. Note in FIGS. 2-3 that secured to posterior surface 186A of core plate 182A is: first upper rail receiver 132A on the upper left side, first lower rail receiver 134A on the lower left side, second upper rail receiver 170A on the upper right side, and second lower rail receiver 172A on the lower right side. Each of these rail receivers have a receiver channel that complements the profile of the rail it is to receive. In some cases, the rail receiver can comprise a linear bearing for eased lateral-medial translation of the first hand assembly and second hand assembly with respect to the core plate 182A.

As noted in the drawings, vertically associated with the first hand assembly and second hand assembly is generally one-half of the chute structures. For example, in this embodiment, first outer chute 224A is fixed vertically to first chute support face 116A whereas second outer chute 230A is fixed vertically to second chute support face 154A. The first outer chute 224A is directly opposed to an upper medial chute 245A superiorly, and a lower medial chute 246A inferiorly. Likewise, the second outer chute 230A is directly opposed to an upper medial chute 245A superiorly, and a lower medial chute 246A inferiorly. The ends of the chutes are flared for eased chain entry as noted by upper flare 236A and lower flare 238A. Guide surface 240A extends along the inside of the chutes guiding the hand chains therethrough. Defined between the opposing chute hemispheres from the superior end is first upper chute portal 226A and first lower chute portal 228A from the inferior end of the first chute, and second upper chute portal 232A from the superior end and second lower chute portal 234A from the inferior end of the second chute. Note that FIGS. 1-2 depict the chutes closed under spring retention (drive or closed configuration) whereas, FIGS. 5-6 depict the hand assemblies distracted wherein the chutes are in a release (or open) configuration for insertion or removal of the hand chains. FIGS. 3, 4 are exploded views of this embodiment.

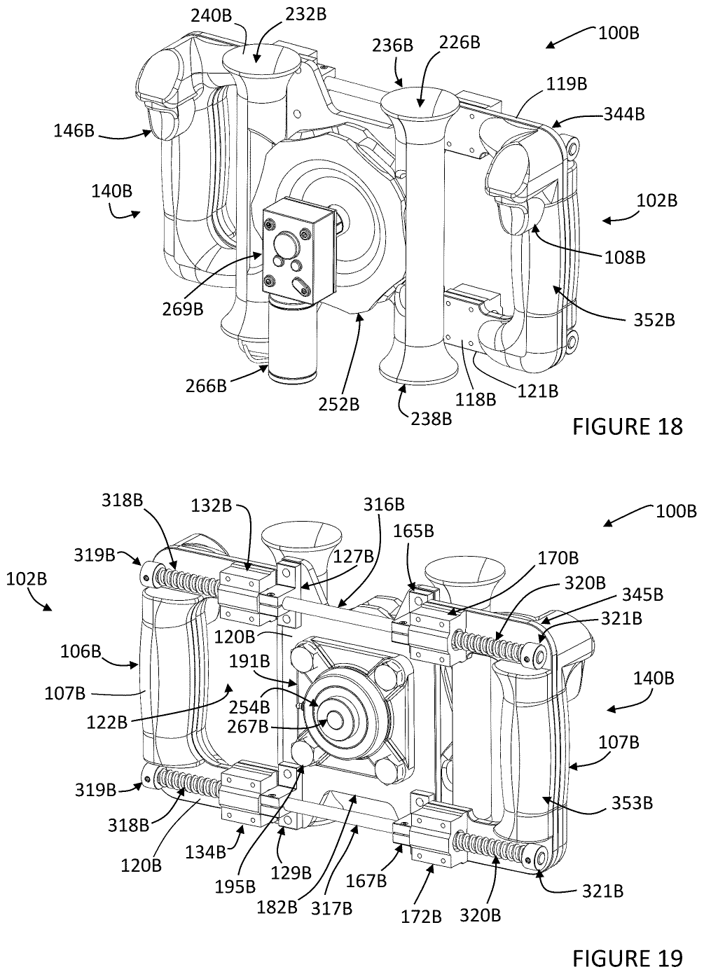

FIGS. 18-19 depict another embodiment of a chain driver 100B. This embodiment includes many of the same elements presented previously as represented by the same feature number and therefore won't be redescribed. However, this embodiment of chain driver 100B comprises several differences. Note that the shroud and battery bracket have been removed from these depictions for better viewing.

Note that this embodiment comprises a top rail 316B (along axis C) and a bottom rail 317B (along axis D). Here the rail is in the form of cylindrical rod. The top rail 316B and bottom rail 317B are secured horizontally to the core plate 182B via rail anchors. For example, a first upper rail anchor 127B and a second upper rail anchor 165B secures top rail 316B to core plate 182B whereas, a first bottom rail anchor 129B and a second bottom rail anchor 167B secures bottom rail 317B to the posterior face 120B of the core plate 182B at each corner. Unlike the rails of the previous embodiment which translate, the top rail and bottom rail depicted here do not translate. Instead, secured to the posterior face 120B of the first hand assembly 102B and second hand assembly 140B are a plurality of rail receivers through which the rails glide.

Also introduced in the FIGS. 18 and 19 embodiment, is a first hand plate 344B and a second hand plate 345B which serve as structural support plates around which the first hand assembly 102B and second hand assembly 140B are formed. These plates are generally U-shaped in this embodiment. In some embodiments, such as depicted here, the first handle 106B and second handle 144B comprise an assembly of the respective hand plate with an anterior handle body 352B and a posterior handle body 353B formed or assembled thereon. The posterior handle body in some embodiments include a plurality of horizontal spring channels 322C formed therein to house a retraction spring(s). A first upper rail receiver 132B is secured to the upper medial aspect of the posterior face 120B of the first hand plate 344B whereas, the first lower rail receiver 134B is secured to the lower medial aspect of the posterior face of the first hand plate 344B. A second upper rail receiver 170B is secured to the upper medial aspect of the posterior face 120B whereas as second bottom rail receiver 172B is secured to the lower medial aspect of the posterior face of the second hand plate 345B.

The ends of the top rail 316B and bottom rail 317B on the first hand assembly are capped off by first stops 319B which in this case is in the form of a collar with set screw. The end of top rail 316B and bottom rail 317B on the second hand assembly are capped off by second stops 321B which in this case is also in the form of a collar with set screw, but could be a crimp, or pin. A first retraction spring 318B is positioned on both the top rail and bottom rail between the first stops and the rail receivers. Likewise, a second retraction spring 320B is positioned on both the top rail and bottom rail between the second stops and the rail receivers. This orientation of the retraction springs causes consequent bias of the hand assemblies towards the middle of the device via pushing against the stops.

Further to this embodiment, the drive motor 266B is aligned 90 degrees to the drive shaft 267B whereas it was previously aligned (FIG. 4) with the drive shaft (axis E). Here, a gear box 269B is utilized between the drive shaft and the drive motor to transfer forces between the motor and drive shaft. A drive coupler (i.e. 271C) can be utilized. Also noted in this embodiment, a bearing housing plate 191B is utilized to house a sprocket bearing 254B in which the drive shaft is supported and spins. Housing plate fasteners 195B are either threaded into the core plate or the fasteners are provided with nuts.

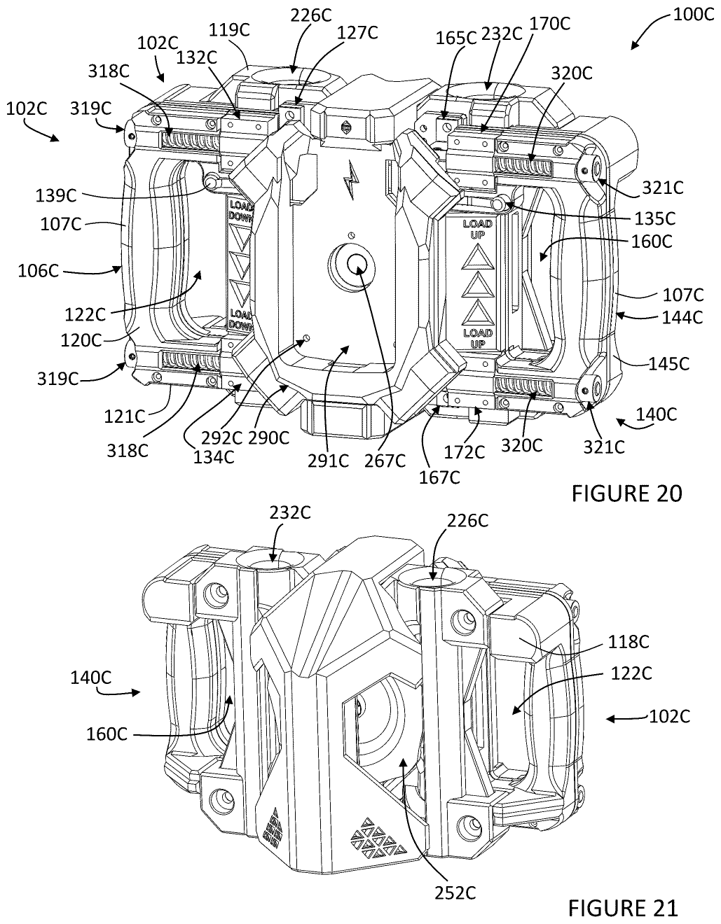

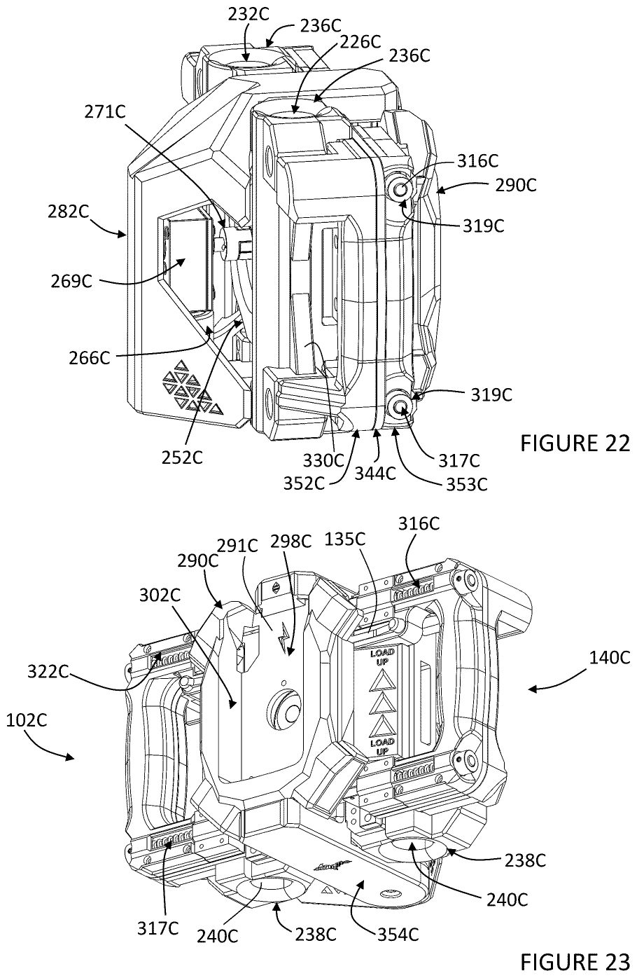

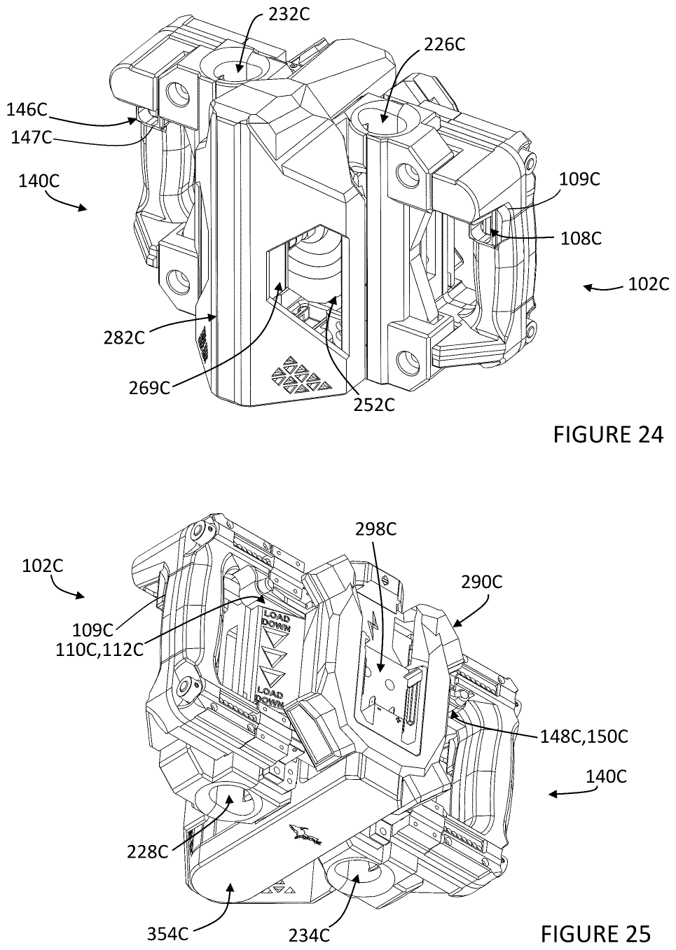

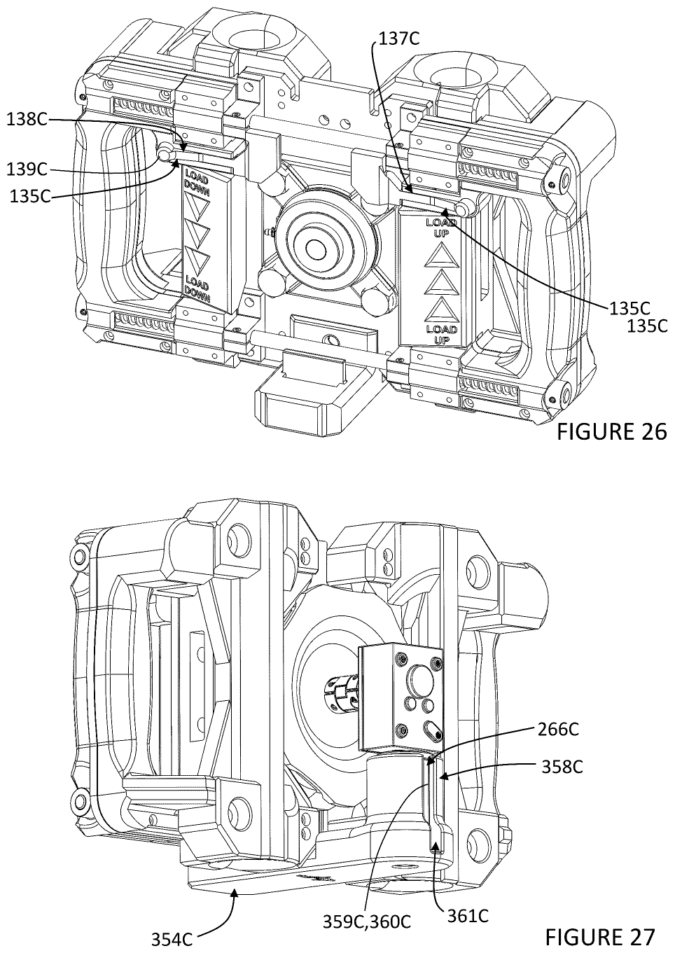

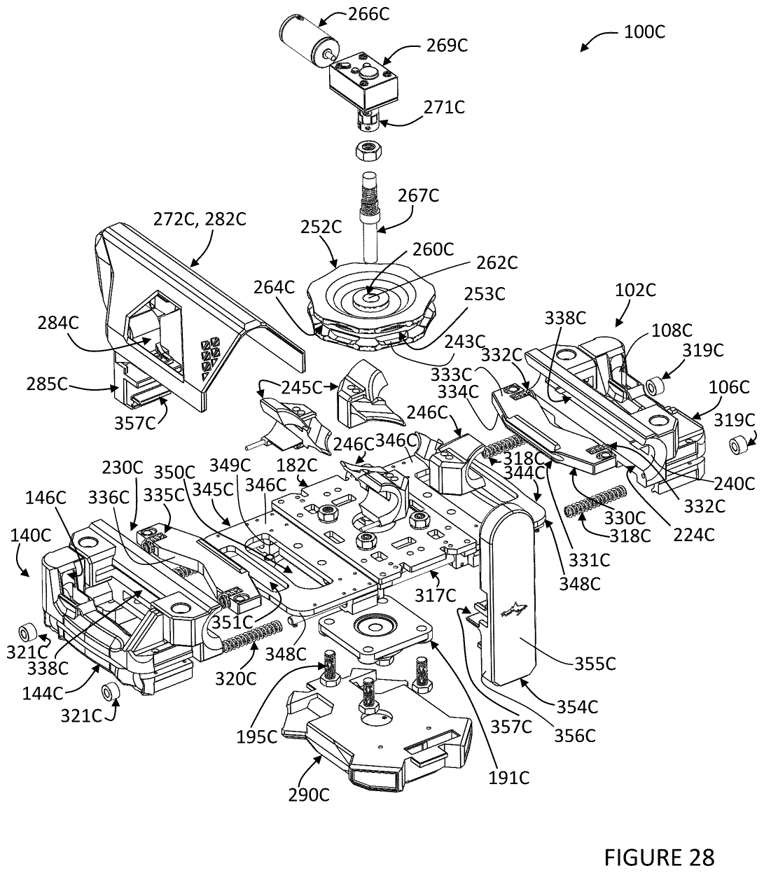

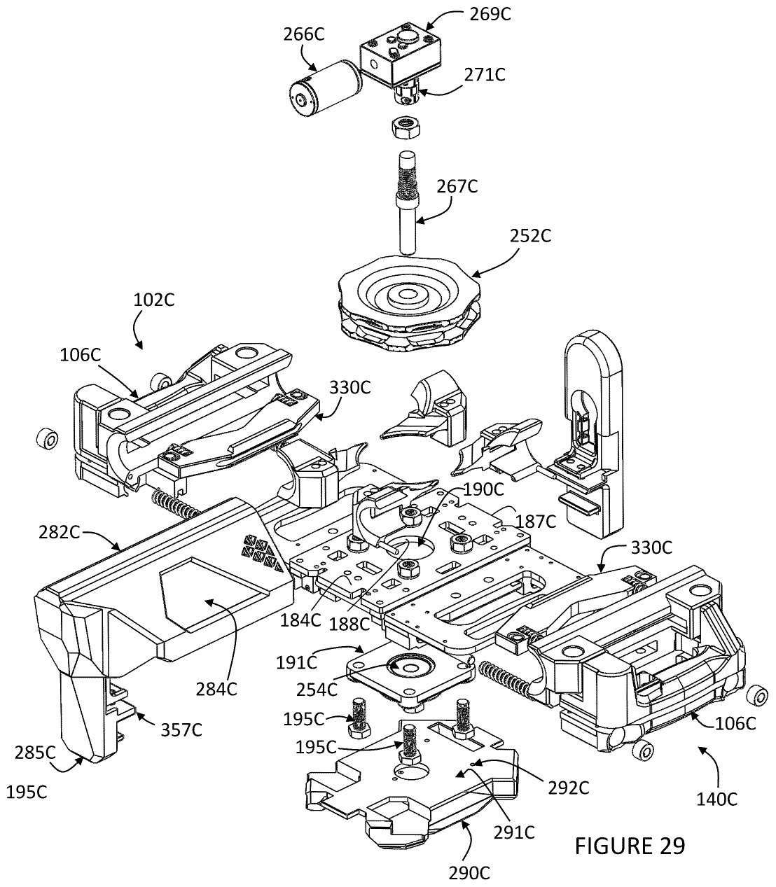

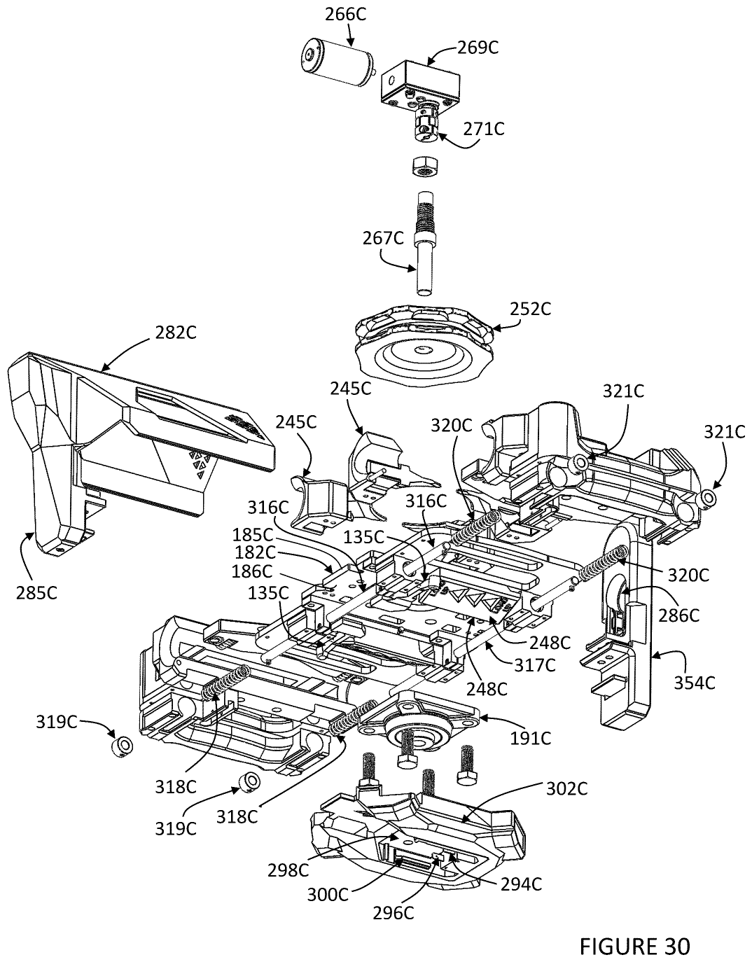

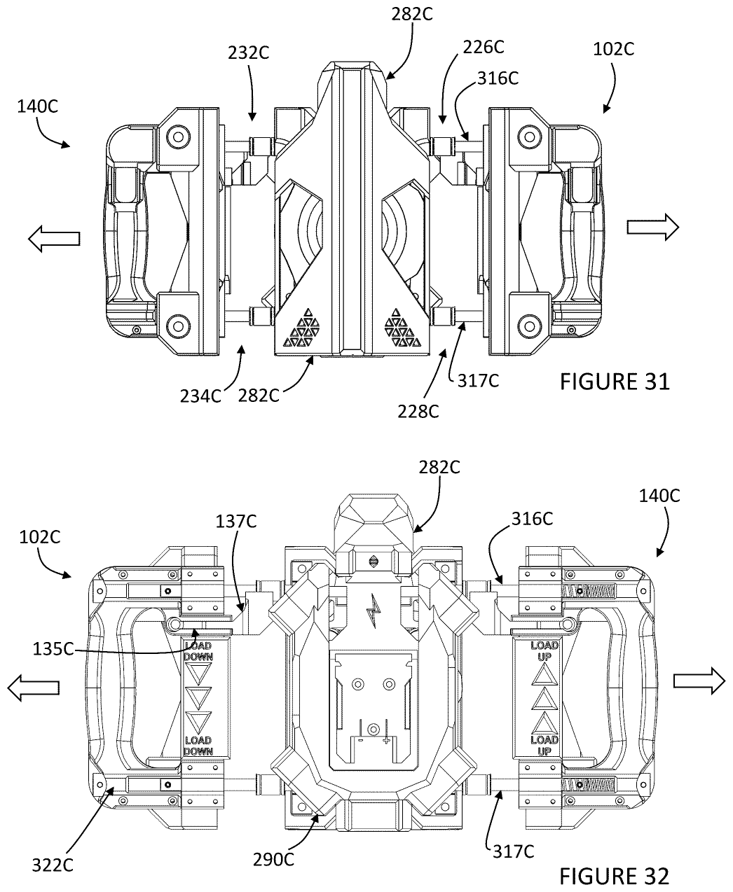

The embodiment depicted in FIGS. 20-34 is similar in many respects to the FIG. 19-20 embodiment. It has been fine-tuned however, in many respects for better engagement of the hand chain, aesthetics, and user experience. Features depicted in the various embodiments can be utilized and combined in a variety of ways as would be recognized by those skilled in the art while still being within the scope of this disclosure. As noted in the exploded view of FIG. 28, the first hand plate 344C and second hand plate 345C are substantially rectangular as defined by perimeter face 348C as opposed to ‘U’ shaped as in the FIG. 19 embodiment. Here the hand plates comprise a finger face 349C that extends between a forward face 346C and a rearward face 347C and which defines a finger cavity 350C which is used to extend a user's fingers through when grasping the first handle 106C and second handle 144C. Lateral to the finger cavity is an electronics cavity 351C which can contain electronic components and conductors.

A shroud 282C is utilized here to protect the user from the drive motor 266C and chain sprocket 252C. The shroud can comprise an upper mount 285C causing the shroud to assume an ‘L’ shape. The shroud preferably has one or more cooling vents 284C to release heat generated through operation of the device. Extending from one portion of the ‘L’ are one or more projections for use as snap joints to secure with components such as top rail 316C and core plate 182C. Positioned inferiorly on the chain driver 100C is foot base 354C which is the primary base on which the device sits. Foot base 354C comprises a downward facing ground face 355C, an outer face 356C that encircles the part laterally, and on the superior side there is one or more snap joints 357C for again coupling with the core plate 182C or bottom rail 317C. In some embodiments, the foot base 354C comprises a motor housing 358C having an inner housing face 359C that defines a motor cavity 360C that at least partially encircles drive motor 266C to provide support. A relief slot 361C extending through a portion of the motor housing can be utilized for fit. In alternative embodiments, the foot base 354C comprises a counterweight or PCB pocket 286C.

Like the embodiment of FIG. 19, the first hand assembly 102C and second hand assembly 140C utilize a first hand plate 344C and a second hand plate 345C, the core of a sandwich on which other components are secured. In this embodiment, the first outer chute 224C and first inner chute 230C are at least partially integrated into the handles. Extending laterally into the guide surface 240C of the chutes is a pair of opposed chain plate ports 338C for housing a chain plate 330C therein. The chain plate 330C is substantially flat and in this embodiment nearly rectangular or in a wide-V profile. The chain plate has a thickness, length and width, for sliding movement within chain plate port 338C. A chain pressure face 331C faces medially to apply a medial force on the hand chain in the chute during operation urging it toward the chain sprocket. One or more chain plate springs 332C seated within chain plate spring seat 335C provide the biasing forces. Opposite the chain pressure face 331C is chain plate trail face 336C. On the broader sides of the chain plate is a chain plate front face 333C facing anterior, and a chain plate rear face 334C facing posterior.

It should be noted that in the assorted embodiments, a variety of assembly fasters 325D within fastener holes 324D can be utilized to hold various parts of the chain drivers together. For the sake of simplicity in the drawings, not all of these fasteners are depicted.

FIGS. 35-37 introduce yet another embodiment of a chain driver 100D having a majority of features introduced in previous embodiments as will be recognized by those skilled in the art. This embodiment comprises a shroud 282D that is taller to accommodate and secure a larger and more powerful superior facing drive motor 266D and gear box 269D within. FIG. 37 depicts a pair of opposing pivot latches 135D that extend between the upper and lower rail anchors. The latches are biased with springs for locking whereby the latch legs 137D pivots to engage the adjacent rail anchor. By depressing the activation pods 139D on each pivot latch 135D and distracting the hand assemblies, the chutes will open for loading/unloading the hand chain 177D.

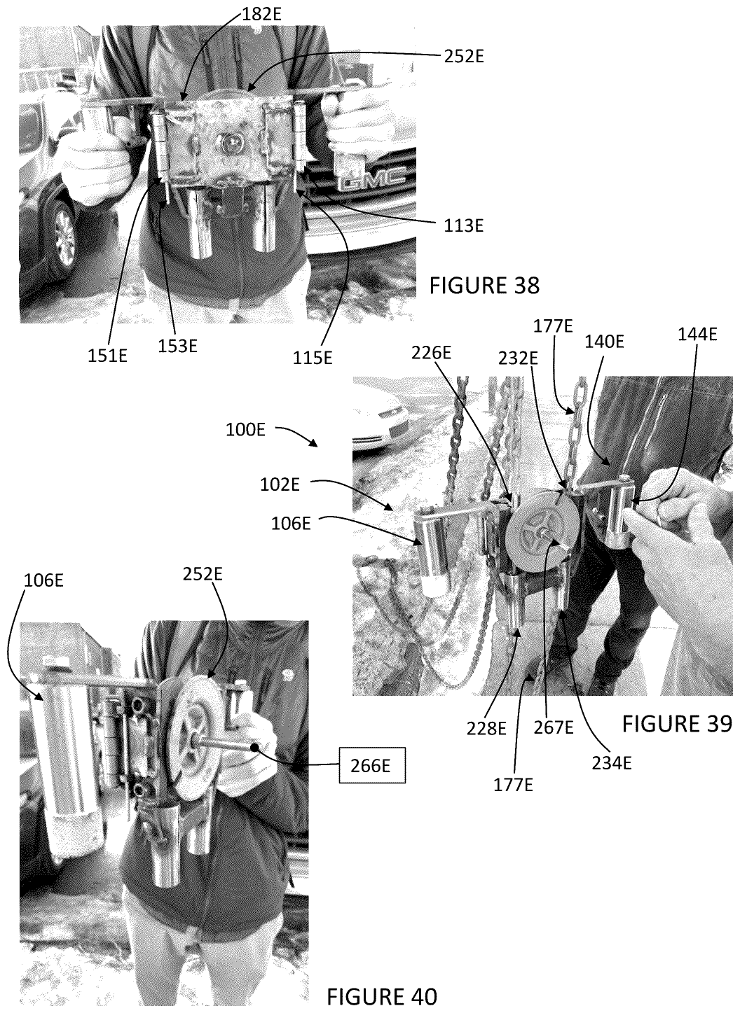

FIGS. 38-40 depict an early prototype chain driver 100E wherein a drive motor 266E is in the form of a cordless or corded drill motor that is releasably attached to drive shaft 267E. The chuck of the drill motor is tightened to drive shaft 267E and activation of the drill motor causes consequent rotation of chain sprocket 252E to drive hand chain 177E through the chutes labeled here as 1^{st} upper chute portal 226E which traverses into 1^{st} lower chute portal 228E, and 2^{nd} upper chute portal 232E which traverses into 2^{nd} lower chute portal 234E. In this embodiment, a first handle 106E on a first handle assembly 102E and a second handle 144E on a second handle assembly 140E are generally vertically positioned and laterally spaced from core plate 182E. The first handle assembly and second handle assembly in this embodiment articulate with core plate 182E via a respective first hinge 113E and a second hinge 151E to pivotably open and close access to the chutes for loading or unloading the hand chain 177E therefrom. A first pin lock 115E is utilized to lock the first chute closed, whereas, a second pin lock 153E is utilized to lock the second chute closed. It is recognized that this hinged version can be equipped with a built-in drive motor, battery, and finger switches.

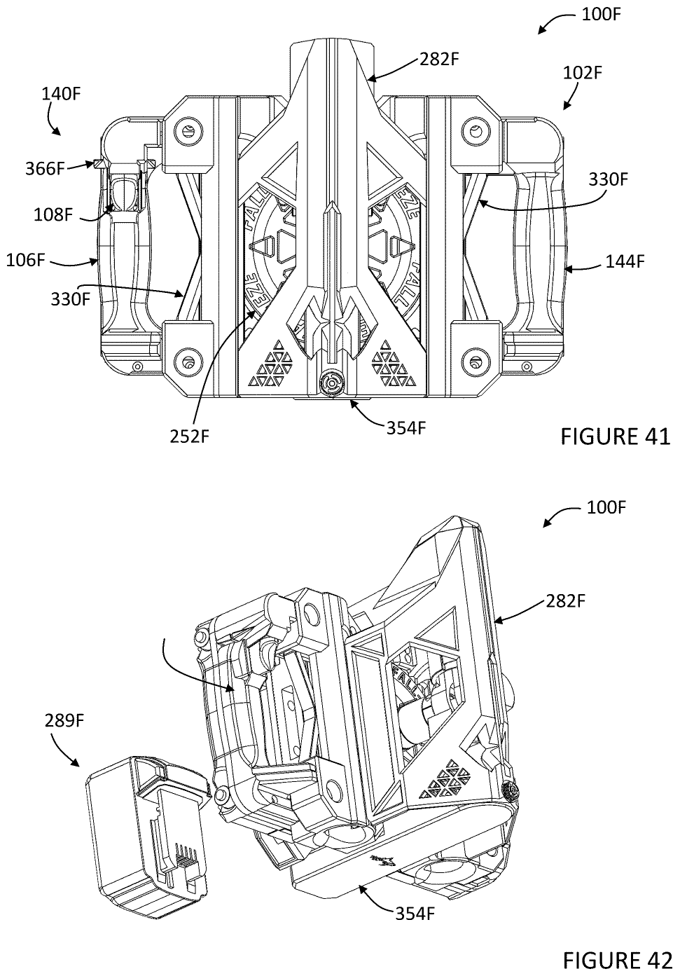

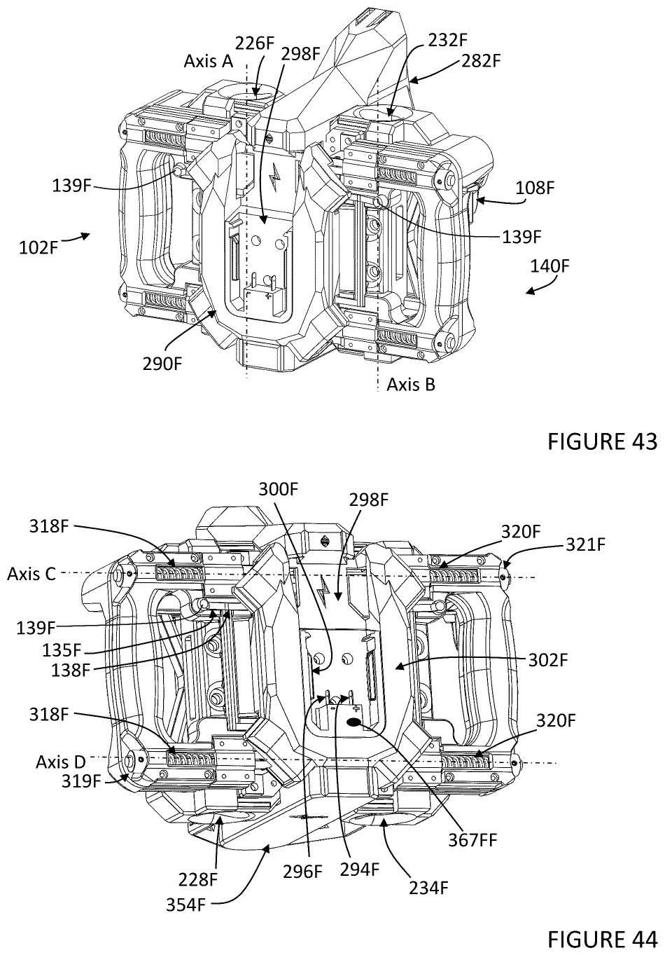

FIGS. 41-48 depict yet another embodiment of a chain driver 100F as a preferred embodiment. The construction of chain driver 100F is very similar to chain drivers 100C and 100D. For example, this embodiment like the previous embodiments, utilizes a first hand assembly 102F and a second hand assembly 140F with a respective first handle 106F and second handle 144F for grasping by a user's hand on each side during operation. Like the previous embodiments, the user can use his thumbs to press activation pod 139F thereby releasing the pivot latch on each side that previously secured first upper chute portal 226F and second upper chute portal 232F to remain in a closed position. With the pivot latch 135F activated, the chutes can be opened by implementing a bilateral distraction force by the user's hands. Both the first hand assembly and second hand assembly then translate laterally along top rail 316F (axis C) and bottom rail 317F (axis D) against first retraction spring 318F and second retraction spring 320F which are biased against the hand assemblies urging them to bias medially and consequently to close the chutes. However, once the chutes are opened, the user can move the chain driver about the hand chains extending from the chain fall such that one chain is aligned within the first chute and the other chain is aligned within the second chute. Relieving the lateral distraction force, the chutes close under force of first retraction spring 318F and second retraction spring 320F and the pivot latches 135F reengage to hold the chutes locked in a closed position. In alternative embodiments, a single rail is used on each hand assembly.

The chain driver 100F relies on a first power switch 108F to control the rotation and speed of chain sprocket 252F depending on whether the chain fall load is being elevated or lowered. In preferred embodiments, drive motor 266F is variable speed and controlled by the distance the first power switch is depressed. The position of directional switch 366F determines the direction of rotation of the chain sprocket.

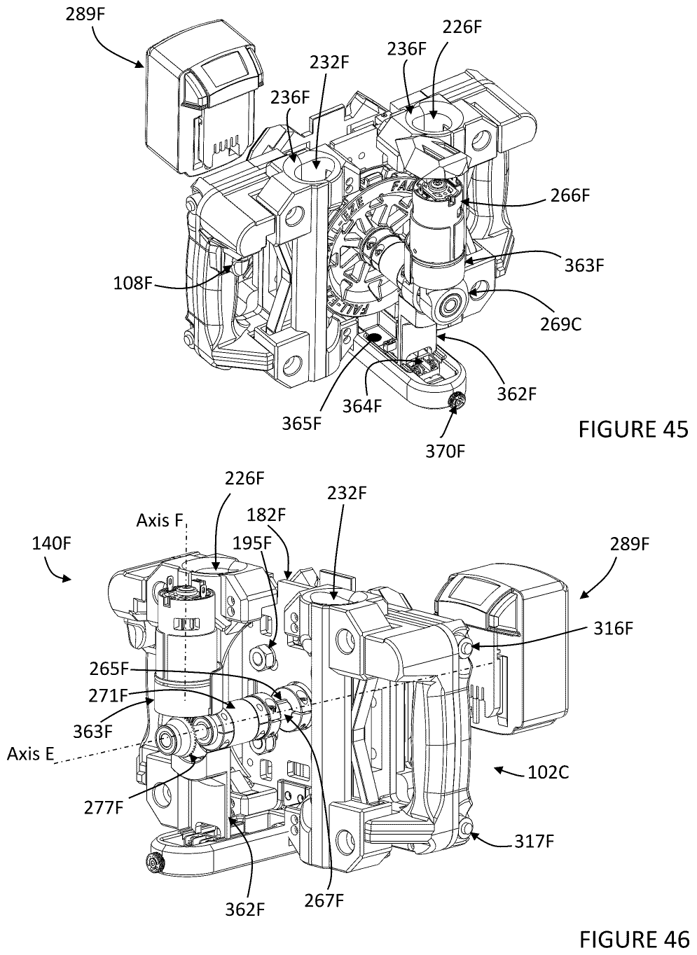

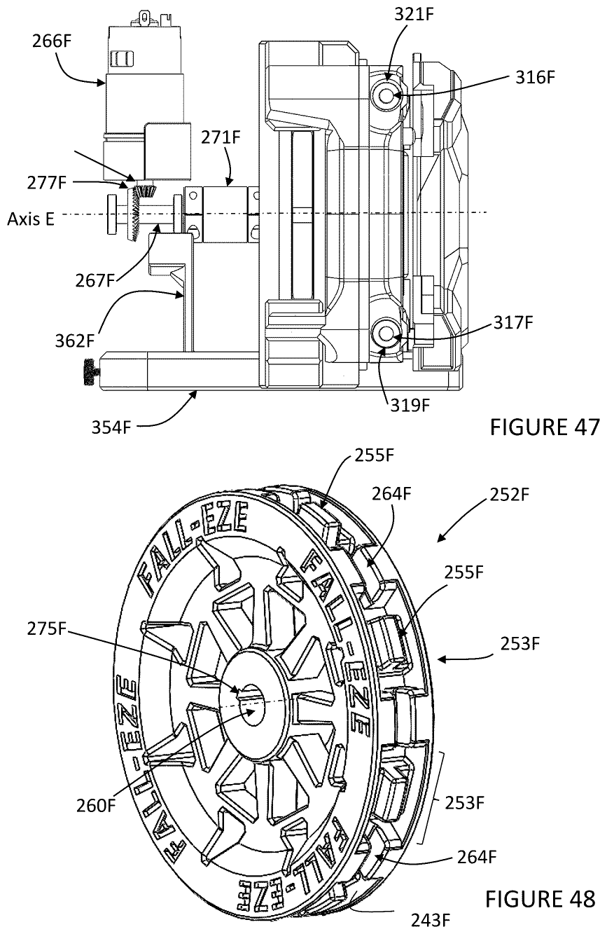

As noted in FIG. 45 which has shroud 282F removed, a slightly different drive motor 266F is utilized that extends upward from gear box 269F. Within the gearbox is bevel gear set 277F (FIG. 47) which transfers force by motor shaft 368F (axis F) of drive motor 266F to drive shaft 267F (axis F) that extends through sprocket drive aperture 260F. Note in this embodiment, that the motor shaft is generally vertical, whereas the motor shaft for motor 266A is generally horizontal. Therefore, orientation of the motor shaft can clearly vary between embodiments. As depicted in FIG. 46, a drive coupler 271F can be used allowing the drive shaft to rotate and flex assuring a constant power transfer. In alternative embodiments, a flexible drive coupler can be used between a motor shaft and drive shafts to provide a range of other angulations therebetween besides 0 degrees and 90 degrees. Drive shaft 267F (axis E) and chain sprocket 252F can include a key recess 275F to accept a shaft key 265F to assure conversion of torque therebetween. Threaded thumbwheel 370F can be utilized to secure shroud 282F in position.

Note also in FIGS. 45-47 that the assembly includes a motor brace 362F having an arced shaped superior end that extends upwards from foot base 354F to support and secure gearbox 269F and consequently drive motor 266F. In addition, a portion of drive motor 266F can be partially encircled by motor bracket 363F at one end to further secure the drive motors. Shroud 282F also offers additional support as it is secured over drive motor 266F. Nestled within footbase 354F is PWM power control board 364F utilizing conductors such as ribbon cable 365F to transfer energy between first power switch 108F, power control board, and drive motor board. Power mains 367F are conductors transferring energy between the battery 289F and drive motor 266F.

Chain driver 100F can utilize different types of chain sprockets. For example, like previous versions, chain sprocket 252F has a plurality of sprocket windows 253F for seating links of the chain in. However, in this embodiment, extending upwards from the center of the sprocket window is an elongate sprocket tooth 255F that is oblong, rectangular, or similar shape and sized to fit within a link recess (i.e. link recess 256D defined by link recess face 258D of a single chain link). Like previous chain sprockets, a sprocket first recess 264F is sized to accept an upstanding chain link within its gap.

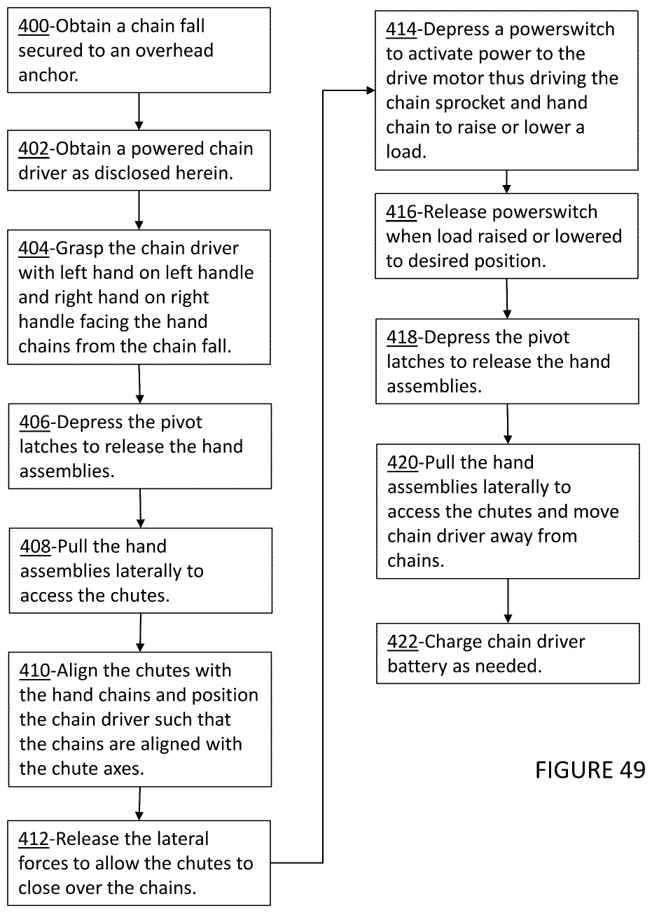

In one embodiment, a method for using a powered chain driver to drive a hand chain comprises the following steps (FIG. 49). Obtaining a chain fall secured to an overhead anchor (400). Obtaining a powered chain driver as disclosed herein (402). Grasping the chain driver with left hand on the left handle and right hand on the right handle while facing the hand chains extending vertically from the chain fall (404). Depressing the pivot latch(s) to release the hand assemblies (406). Pulling the hand assemblies laterally to open the chutes and providing access to them (408). Aligning the chutes with the hand chains and position the chain driver such that the chains are aligned with the chute axes (410). Releasing the lateral forces to allow the chutes to close over the hand chains (412). Without releasing the handles, depressing a power switch on the chain driver to activate power to the drive motor, thus driving the chain sprocket and hand chain to raise or lower a load suspended by the chain fall (414). Releasing the power switch when the load is raised or lowered to the desired position (416). Depressing the pivot latches to release the hand assemblies (418). Pulling the hand assemblies laterally to access the chutes and moving the chain driver away from the hand chains (420). Charging the chain driver battery as needed (422).

Due to the extensive list of features that are duplicated in a variety of embodiments herein, duplicate labeling of repeated features and repeated discussion of repeated features has been avoided where possible to avoid confusion.

It is noted that the terms “substantially” and “about” and “generally” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The foregoing invention has been described in accordance with the relevant legal standards, thus the description is exemplary rather than limiting in nature. Variations and modifications to the disclosed embodiment may become apparent to those skilled in the art and fall within the scope of the invention.

1. A powered handheld chain driver for driving a chain from a chain fall in an operable mode comprising:
a core plate centered in said chain driver operable to provide chain driver structural support;
a chain sprocket;
said chain sprocket comprising a plurality of sprocket windows inset on the radial perimeter of said chain sprocket for driving links of a chain;
a sprocket first recess;
said plurality of sprocket windows linked by said sprocket first recesses;
a drive motor;
a drive shaft;
said drive shaft coupled to said drive motor and operable to impart torsion on said chain sprocket;
a first chute for directing chain against said chain sprocket;
a second chute for directing chain against said chain sprocket on an opposing side of said chain sprocket;
said first chute spaced parallel to said second chute with said chain sprocket positioned therebetween;
said drive motor and said drive shaft and said chain sprocket coupled to said core plate;
a first handle;
a second handle;
said first handle positioned lateral to said first chute;
said second handle positioned lateral to said second chute; and,
wherein activation of said drive motor induces consequent rotation of said chain sprocket.

2. The powered handheld chain driver of claim 1 further comprising:
a battery;
said battery coupled to one side of said core plate; and,
wherein said drive motor is coupled to the other side of said core plate.

3. The powered handheld chain driver of claim 1 further comprising:
a first hand assembly;
a second hand assembly;
wherein said first hand assembly and said second hand assembly are biased medially toward said core plate.

4. The powered handheld chain driver of claim 3 further comprising:
an upper rail;
a lower rail; and,
wherein said first hand assembly and said second hand assembly are guided in lateral translation by said upper rail and said lower rail.

6. The powered handheld chain driver of claim 1 further comprising:
a pivot latch;
wherein said pivot latch secures said first hand assembly adjacent said core plate such that said first chute remains closed.

5. The powered handheld chain driver of claim 1 further comprising:
one or more springs;
wherein said one or more springs bias said first handle and said second handle medially thereby closing said first chute and said second chute.

6. The powered handheld chain driver of claim 1 further comprising:
a battery bracket;
wherein said battery bracket is fixed to said core plate.

7. The powered handheld chain driver of claim 1 further comprising:
a bevel gear set;
wherein said bevel gear set transfers torque from said drive motor to said drive shaft.

8. The powered handheld chain driver of claim 1 further comprising:
a sprocket drive aperture;
said sprocket drive aperture extending through said chain sprocket for receiving said drive shaft;
a key recess in said drive shaft and in said sprocket drive aperture;
a shaft key;
said shaft key locking interlocking said chain sprocket with said drive shaft.

9. The powered handheld chain driver of claim 1 further comprising:
a drive coupler;
said drive coupler joining two portions of said drive shaft.

10. The powered handheld chain driver of claim 1 further comprising:
a gearbox;
a bevel gear set;
said bevel gear set contained in said gear box.

11. The powered handheld chain driver of claim 1 further comprising:
a foot base;
said foot base secured perpendicular to said core plate at an inferior end;
a motor brace;
said motor brace extending superiorly from said foot base to support said gear box.

12. The powered handheld chain driver of claim 1 further comprising:
a drive motor shaft;
said drive motor shaft generally vertical; and,
wherein said drive shaft is generally horizontal.

13. The powered handheld chain driver of claim 1 further comprising:
a hinge;
said hinge articulating between two portions of at least one of said chutes; and,
wherein said hinge is operable to open and close said at least one of said chutes to provide loading and unloading of chain therein.

14. The powered handheld chain driver of claim 1 wherein said drive shaft is driven by an electric drill motor.

15. The powered handheld chain driver of claim 1 wherein said chain sprocket comprises a sprocket tooth extending radially from said sprocket window for engaging the inside of a chain link.

16. The powered handheld chain driver of claim 1 further comprising:
a vertical chain plate biased medially into one or more of said chutes operable to press a chain toward said chain sprocket.

17. A method of using a powered chain driver to drive a hand chain comprising:
obtaining a chain fall secured to an overhead anchor;
obtaining a powered chain driver;
grasping the chain driver with a hand on a left handle and a hand on a right handle of the chain driver;
pulling the hand assemblies laterally to access chutes in the chain driver;
aligning the chains extending from the chain fall within the chutes of the chain driver;
releasing the lateral forces such that the chutes close around each chain;
activating a drive motor to turn a chain sprocket in the chain driver that engages the chains in the chutes to raise or lower a load attached to the chain fall.

18. The method of using a powered chain driver to drive a hand chain of claim 17 further comprises:
depressing a power switch adjacent one of the left handle or the right handle to activate the drive motor.

19. The method of using a powered chain driver to drive a hand chain of claim 17 further comprises:
depressing a pivot latch to provide access to one or more of the chutes.

20. The method of using a powered chain driver to drive a hand chain of claim 17 further comprises:
pulling the hand assemblies laterally to access chutes in the chain driver and releasing the hand chains from the chutes for removal of the chain driver from the chain fall.
